(19) United States
(12) Patent Application Publication
(10) Pub. No.: US 2014/0196072 A1
(43) Pub. Date: Jul. 10, 2014

(54) DIGITAL MULTIMEDIA CONTENT INTEGRATION SYSTEM CLAIM OF BENEFIT TO PRIOR APPLICATION

(71) Applicant: THOMAS AQUINAS BAGWELL, GLENDORA, CA (US)

(72) Inventor: THOMAS AQUINAS BAGWELL, GLENDORA, CA (US)

(21) Appl. No.: 14/146,695

(22) Filed: Jan. 2, 2014

Related U.S. Application Data
(60) Provisional application No. 61/749,133, filed on Jan. 4, 2013.

(51) Int. Cl. H04N 21/4784; H04N 21/81

(52) U.S. Cl. CPC H04N 21/4784; H04N 21/812
USPC 725/23

(57) ABSTRACT

Some embodiments include a process for providing free, consumer-controlled multimedia content to consumers and a digital multimedia content integration system that integrates subsystems for content distribution, advertising, marketing, and sales in each of a set of multimedia content platforms. Using the system, a content viewer can watch new content free of monetary charge. The content viewer is hosted, in some embodiments, by an announcer associated with one or more content items. The content watched by the viewer is free of commercial interruptions and the viewer gets rewarded sweepstakes points for every click and view, including branded and charity content associated with a content item episode. In some embodiments, each show episode directly benefits a local charity.

### CLAIM OF BENEFIT TO PRIOR APPLICATION

This application claims benefit to U.S. Provisional Patent Application 61/749,133, entitled “F2TP Digital Integration Systems is a digital distribution, advertising, marketing and sales web portal based on a video platform known as FREE2thePUBLIC.com,” filed Jan. 4, 2013. The U.S. Provisional Patent Application 61/749,133 is incorporated herein by reference.

### BACKGROUND

Embodiments of the invention relate to content delivery systems that distribute content in multiple digital formats, provide advertising, marketing, and sales platforms in relation to multiply-formatted and system-distributed digital media content.

In today's digital world, viewers and/or consumers want to watch free video content without commercial interruption while multitasking; shopping, downloading coupons and offers, voting, commenting, participating in contests, donating to charity and “one-step” sweepstakes incentives—all while having their privacy protected. Advertisers want to utilize all of these digital processes to display, offer and sell their products with an ROI.

There are a number of other content distribution systems available which could have addressed the needs of consumers and advertisers. However, to date, none of the existing systems has created a way to give the consumer/viewer and the advertiser what they want and need. The other systems are not hosted and presented in a television broadcast manner. The other systems are all predicated on watching re-runs of current television series. The other systems also do not have integrated connections with the advertisers to make offers without having to leave the current site and go to the advertiser site. The other systems do not reward the viewers with automatic sweepstakes prizes for every single episode or without having to perform additional steps and give up additional personal information. The other systems do not provide the advertisers with solid hard data because it is all attached to personal data.

Therefore, what is needed is a digital integration system that brings all of the success components together for the viewer/consumer and the advertiser, and in which the viewer/consumer is hosted by announcers that help keep the viewers moving, thereby allowing the viewer to watch, for free, new content that is written, produced, directed, and acted in by Hollywood's finest and which does not include commercial interruptions but where the viewer gets paid with unlimited sweepstakes points for every click and view, including branded and charity content associated with content items (e.g., programming episodes, etc.). Furthermore, the system should be able to benefit a local charity for each episode of every show.

### BRIEF DESCRIPTION

Some embodiments include a novel process for providing free, consumer-controlled multimedia content to consumers in a digital multimedia content integration system that integrates subsystems for content distribution, advertising, marketing, and sales in each of a set of multimedia content platforms. In some embodiments, a content viewing consumer can watch new content free of monetary charge. In some embodiments, the content viewer is hosted by an announcer associated with one or more content items. The content watched by the viewer, in some embodiments, is free of commercial interruptions. In some embodiments, the viewer gets rewarded sweepstakes points for every click and view, including branded and charity content associated with a content item episode. In some embodiments, each show episode directly benefits a local charity.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process of a digital integration system in some embodiments for providing free, consumer-controlled multimedia content to consumers.

FIG. 2 is a continuation of the digital integration system process of FIG. 1.

FIG. 3 is a continuation of the digital integration system process of FIG. 2.

FIG. 4 is a continuation of the digital integration system process of FIG. 3.

FIG. 5 conceptually illustrates another digital integration system process for providing free, consumer-controlled multimedia content to consumers in some embodiments.

FIG. 6 conceptually illustrates an electronic system with which some embodiments of the invention are implemented.

### DETAILED DESCRIPTION

Some embodiments include a novel process for providing free, consumer-controlled multimedia content to consumers in a digital multimedia content integration system that integrates subsystems for content distribution, advertising, marketing, and sales in each of a set of multimedia content platforms. In some embodiments, a content viewing consumer can watch new content free of monetary charge. In some embodiments, the content viewer is hosted by an announcer associated with one or more content items. The content watched by the viewer, in some embodiments, is free of commercial interruptions. In some embodiments, the viewer gets rewarded sweepstakes points for every click and view, including branded and charity content associated with a content item episode. In some embodiments, each show episode directly benefits a local charity.

In some embodiments, a process is performed within the digital integration system. The process of some embodiments includes (i) hosting content for a viewer to watch, (ii) performing a set of initialization operations, (iii) receiving a content selection to play for the viewer, (iv) displaying a sequence of clips from the playing content, (v) while the content is playing, displaying a content-associated token that increases a point value awarded to the viewer for viewing the content, (vi) transmitting the point value to a computing device of the viewer after the content finishes playing, (vii) displaying a set of selectable sponsor content links which when selected transmits a set of quasi-cash rewards to the computing device of the viewer, and (viii) in each of a plurality of categories, selecting a set of winning viewers of the content.

In some embodiments, a content consumer is invited to be a viewer of content received from a website (i.e., the viewer can watch content streamed from a content database or a social network site and displayed on a display screen of a computing device of the viewer). In some embodiments, the content being watched includes a host/announcer who tells the viewer to login with email address and zip code. When the viewer is not registered, the announcer explains that this is the only time the viewer has to register. The announcer also explains that sweepstakes points are awarded every time the viewer visits the site and logs into the system, as well as every time they click on any button within or adjacent to the content being played. The viewer is told that clicking on sponsor logos, which are displayed adjacent to the content being played, and watching any of the associated branded viral videos will get them even more points. The same applies to watching the charity video for each episode.

After this introduction by the announcer, the viewer is invited to click on a “channel” and click on a show to watch an episode. In some embodiments, all click-able items (e.g., channels, logos, buttons, options, etc.) are graphical user interface (GUI) items that are displayed according to instructions of a program that is running on a processor of the computing device that is contemporaneously receiving the stream of data of the content and displaying the content for viewing on the display screen. While the content is playing, no commercials are shown. The viewer is in total control and when the viewer clicks on any button, the content stops. Each page has a “Return To Show” GUI button that resumes playing the content.

In some embodiments, the viewer is given a “magic word” at the end of each episode which doubles the number sweepstakes points awarded for that episode. After the “magic word” is announced, in some embodiments, the viewer is encouraged to click on GUI items representing sponsor logos and other items for watching the videos, receiving coupons automatically, sharing with friends, and entering the “magic word” to receive sweepstakes points. The viewers are reminded that they also receive bonus sweepstakes points for watching the charity video.

In some embodiments, at the end of each week, the total sweepstakes points from every single login email address for every single episode are entered into an electronic server and a randomized sweepstakes software is used to choose the winners in each category. There are multiple sweepstakes prizes for every episode of every show. The sweepstakes software selects multiple winners, sometimes more winners than will be rewarded, as some winners will not accept the prize due to tax payments. In some embodiments, the sweepstakes software selects the winners randomly from a pool of sweepstakes points that can be traced to the individual viewers.

In some embodiments, all viewers automatically receive coupons at login to each episode. The coupons can be loaded onto a computing device of the viewer (e.g., a smartphone, a smart TV, a tablet computing device, a desktop computer, etc.) or onto a retail loyalty card registered with the digital integration system. Also, some random coupons are coded with added sweepstakes prize rewards and are remunerated at the cash register upon redemption at the participating retailer.

In this way, the digital integration system delivers TV quality entertainment content on a full screen, on any digital device, without any commercial interruptions. When viewers click to interact, content stops, thereby allowing the viewer to shop, watch branded content, etc. Registered viewers receive incentive points for every time they click a button on the digital integration system site (e.g., website hosted by a web server). These points are entered into recurring (e.g., weekly) sweepstakes, with many winners (e.g., hundreds, thousands, etc.) on every episode. Rewards can be anything that a viewer would value. For instance, rewards for one sweepstakes drawing may include a new car, a high-end interactive and web-capable HDTV and/or UltraHD TV, and several hundred cash and/or quasi-cash rewards (e.g,, gift certificates redeemable for $50 in merchandise at a retailer). The system also incorporates the advertisers as part of the sweepstakes, randomly rewarding viewers for online or in-store purchases. Manufacturers and retailers are provided with a full screen page to display their branded video content. A charity page with gives manufacturers and retailers a chance to engage in cause-related sales programs.

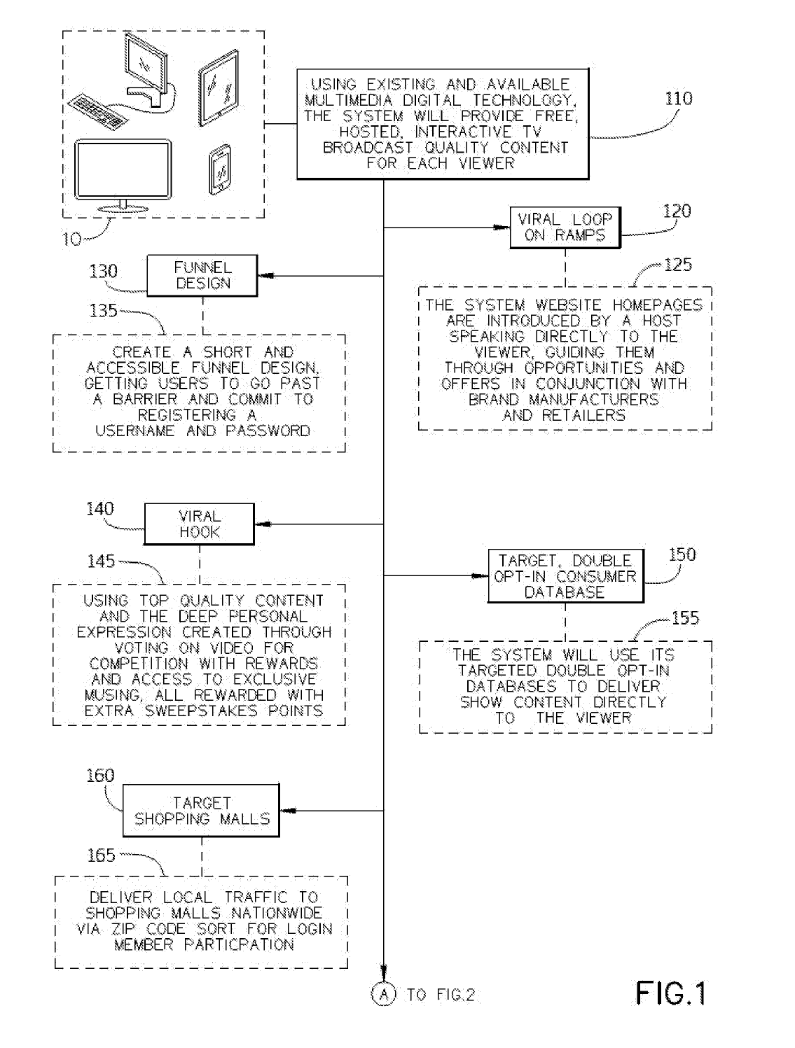

FIGS. 1-4 conceptually illustrate a process of an example digital integration system that provides free, consumer-controlled multimedia content to consumers. As shown in FIG. 1, the process (at 110) uses existing and available multimedia digital technology to provide free, hosted, interactive TV broadcast-quality content for each viewer. In doing so, the process is performed by one or more components of the digital integration system in some embodiments. By way of example and as shown in FIG. 1, the digital integration system includes a set of viral loop on-ramps 120 through which (at 125) the system website home pages are introduced by a host speaking directly to the viewer, guiding them through opportunities and offers in conjunction with brand manufacturers and retailers. In some embodiments, the process creates the entryways into the viral loop as a first phase to creating viral media. There are many manners of delivery, but in some embodiments, the process delivers e-mails to e-mail addresses stored in an opt-in database (i.e., consumers who have voluntarily requested e-mail messages), and collect additional opt-in members from social network incentives, and associate web sites that guide their members to the system.

The digital integration system of some embodiments also includes a funnel design 130. In some embodiments, the process creates (at 135) and short and accessible funnel design, thereby getting users to go past a barrier point and commit to registering a username and password. Once registered, the process begins using high rated content (at 145) in a viral hook subsystem 140. The system also allows users to personally express themselves and be rewarded with quasi-cash awards, such as sweepstakes points. Thus, the system gets viewers to return to the web site of the system by having a viral hook subsystem that provides top quality entertainment content, and that allows the deep personal expression created through exclusive voting, uploading video for competition with rewards, access to exclusive music, all of which, when selected, reward the viewer with additional sweepstakes entries, as a means of getting people to want to put our applications on their desktops, tablets or mobile phones.

A database 150 for targeted, double opt-in consumers is accessed by the process in order to deliver (at 155) show content directly to viewers in some embodiments. Through a set of target shopping malls 160, the process delivers (at 165) local traffic to shopping malls nationwide which are zip-code sorted for member participation when logged into the digital integration system.

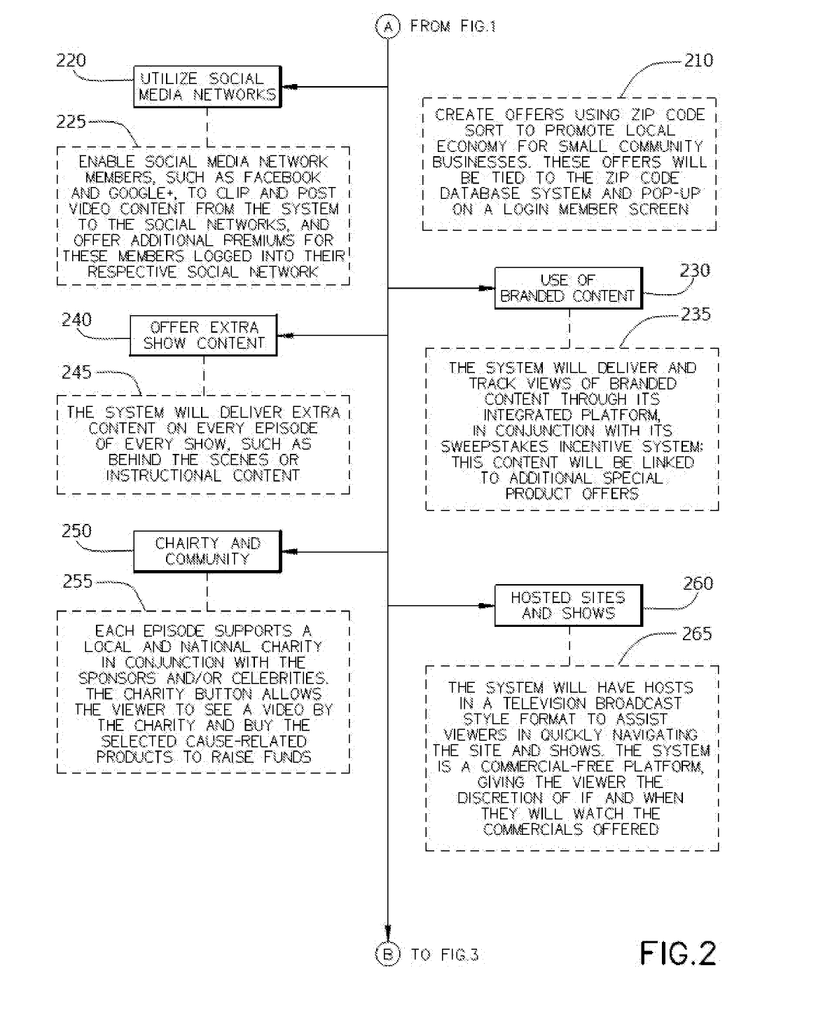

In FIG. 2, the process creates (at 210) offers using zip code-sort to promote the local economy for small community businesses. These offers are tied to the zip code database subsystem and are displayed in a pop-up log-in member screen. However, the process is not limited to only these features. In some embodiments, the digital integration system includes a social media network subsystem 220 that allows the process to enable (at 225) social media network members to clip and post video content from the system to the respective social network. For instance, the user could be a member of Facebook or Google +. In some embodiments, the process also offers (at 225) additional premiums for members who are presently logged into their respective social network.

The system of some embodiments also includes a subsystem to use branded content 230. In these embodiments, the process delivers and tracks (at 235) views of branded content through the system's integrated platform, in conjunction with the sweepstakes incentive system, and thereby provides content linked to additional special offers for products and/or services. The system of some embodiments includes a subsystem that offers extra show content 240, such that the system will deliver (at 245) extra content of every show. For example, extra content such as behind the scenes footage or instructional content may be delivered to interested viewers.

A charity and community subsystem 250 is included in some embodiments of the digital integration system. This subsystem 250 allows the process to support (at 255) local and national charities for each episode, in conjunction with the sponsors and/or celebrities of the show. In some embodiments, the charity and community subsystem 250 is activated by a charity button, which when selected, allows the process to display (at 255) a video by the charity and to pay for the products that help support the charity's cause. Upon clicking on the charity video, a “thank you” video is sent to the viewer featuring the company and or celebrity that is driving the charity program.

Another subsystem for hosted sites and shows 260 ensures that the system will have hosts in a television broadcast-style format to assist viewers in quickly navigating the site and shows. Since the digital integration system offers a commercial-free platform, the process is able to give the viewer (at 265) discretion in watching ads associated with one or more episodes of a show.

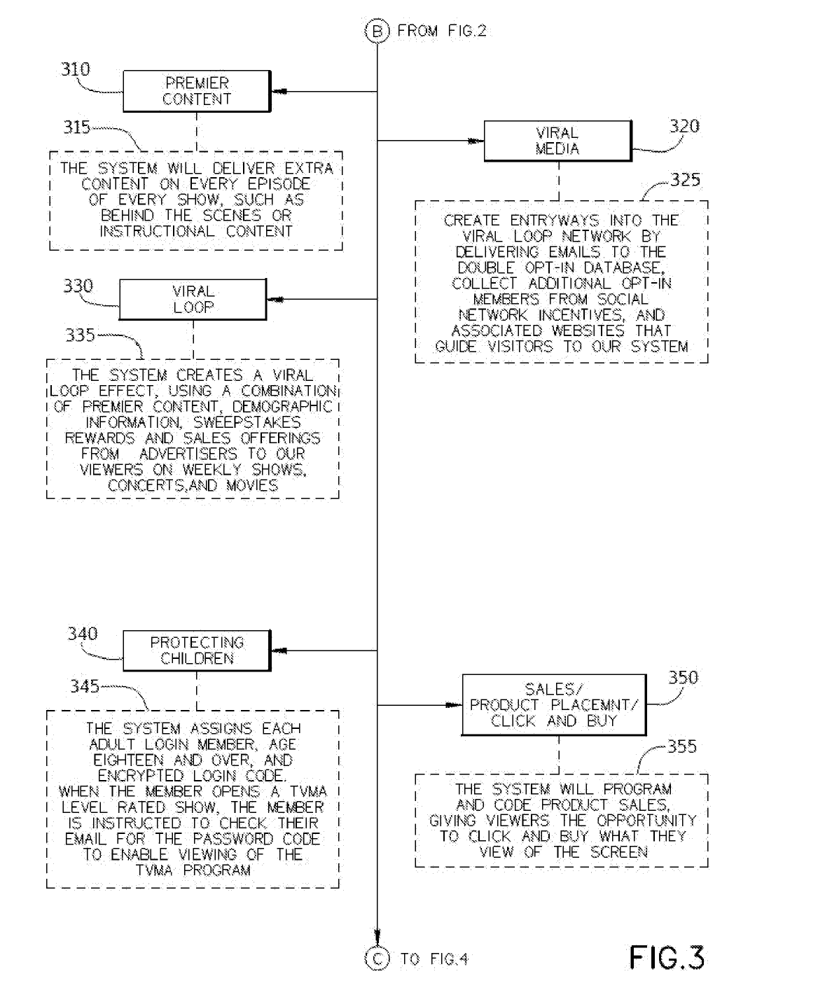

As shown in FIG. 3, the digital integration system of some embodiments includes a premier content subsystem 310 that allows the process to deliver (at 315) extra content on every episode of every show. As through the branded content subsystem 230, the premier content subsystem 310 provides viewers access to behind the scenes footage or other content. Likewise, a viral media subsystem 320 acts like the viral loop on ramps 120 when the process creates (at 325) entryways into the viral loop network by delivering emails to the double opt-in database 150.

In some embodiments, this allows the process to collect (at 325) additional opt-in members from social media network incentives and associated websites that guide visitors to the digital integration system. In some embodiments, the digital integration system includes a viral loop subsystem 330 through which the process creates (at 335) a viral loop effect for viewers on weekly shows, concerts, movies, etc. The system creates the viral loop effect in some embodiments using a combination of premier content, demographic information, sweepstakes rewards and sales offerings from our advertisers, to our viewers on weekly shows and concerts.

A subsystem for protecting children 340 is available in the system such that the process assigns (at 345) each adult login member of valid legal age (i.e., 18 years or older) an encrypted login code. In some embodiments, the encrypted login code comprises a set of alpha-numeric characters. In some embodiments, the set of alpha-numeric characters of the encrypted login code comprises 10 numbers and 10 letters. When a login member clicks to open an adult (i.e., TVMA level) rated show, the screen message instructs the login member to check their email for the password code for this TVMA programming. By restricting the content that a viewer can watch through encryption, younger viewers are protected. For instance, if the viewer selects an episode of a show that is rated for mature (i.e., 18 and over) audiences, the viewers with appropriate ages will be instructed to retrieve a password code (e.g., from email, from SMS text, etc.) to view the age-restricted content. The digital integration system thereby prevents children under the age of 17 from opening and viewing content rated at a level higher than the rating for the age group demographic.

The system of some embodiments also includes a sales/product placement/click-and-buy subsystem 350 that is able to program and code (at 355) one or more product sales, thereby allowing immediate purchasing of items as they view them on the screen.

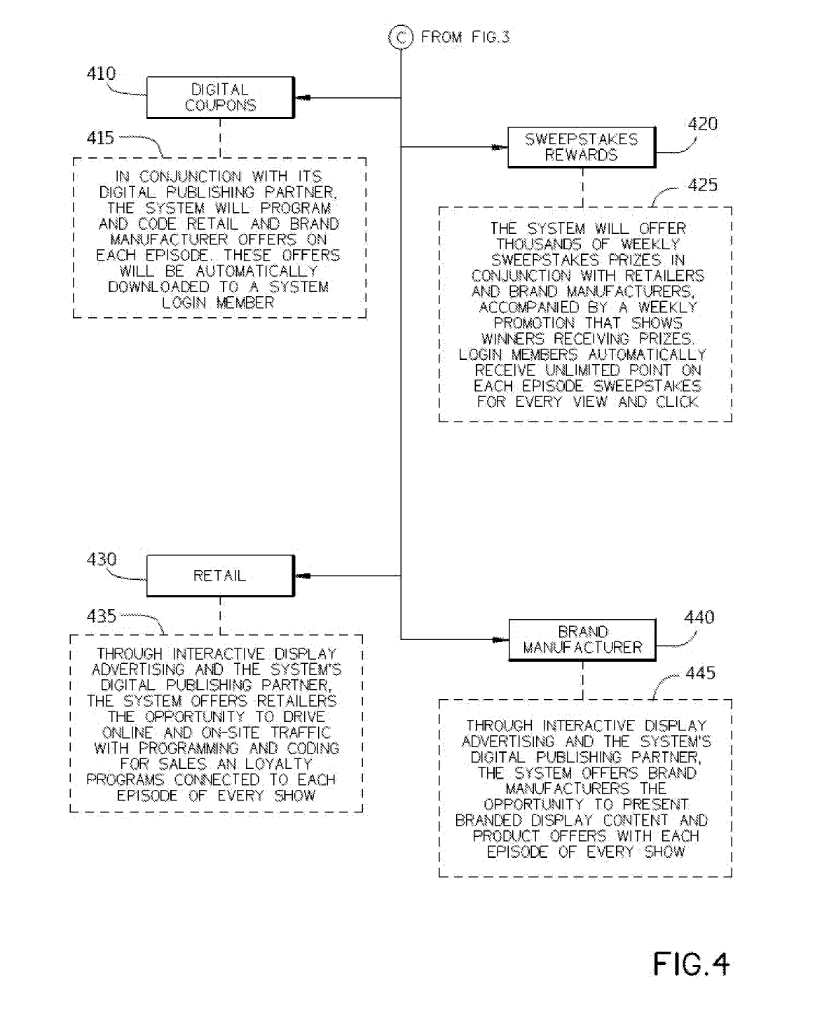

As shown in FIG. 4, the digital integration system includes a subsystem for the distribution of digital coupons 410. This subsystem 410 allows the process of some embodiments, in conjunction with its digital publishing partner (if any), to program and code (at 415) retail and brand manufacturer offers for each content episode. For example, an episode of a 1950s sitcom may include branded replica leather jackets which were popular during that time period and which are currently produced by a manufacturer specializing in retro fashion garments. In some embodiments, a sweepstakes rewards subsystem 420 allows the process to offer (at 425) recurring sweepstakes prizes which are provided in conjunction with retailers and brand manufacturers. Such sweepstakes may be enhanced by weekly promotions that award winners. For example, weekly shows may display a promotional contest in which winners are shown on TV winning prizes and/or awards. Viewers can view content to add to their accumulated point total.

A retail subsystem 430 and brand manufacturer subsystem 440 round out the subsystems of the digital integration system in some embodiments. Through interactive display advertising and the system's digital publishing partner, in some embodiments, the process offers (at 435) retailers opportunities to drive online and on-site traffic with programming/coding for sales and loyalty programs connected with each episode of every content show. Likewise, the process offers (at 445) manufacturers the opportunity to present branded display content and product offers.

In some embodiments, the process is implemented as a program that executes on a processor of a computing device. In some embodiments, the software is offered to each login member and can be engaged or disengaged on each show depending upon the viewer's preference. In some embodiments, the channel “host” guides the viewer to the special “sales” tools, which in some embodiments are displayed as graphical user interface (GUI) buttons, widgets, menu items, etc., and which allow a viewer to buy the item offered on a content episode or concert that is presently being streamed from a web server to the computing device of the viewer so that the view can watch the episode or concert. In some embodiments, the process is implemented in a way that allows one click placement of a product in the login member's reserve basket. In some embodiments, the program automatically sends a text and/or an email verification of the one-click placement of the product. There are a variety of different options that are implemented depending on the directed sales (e.g., shopping malls, grocers, branded retailers, manufacturers, etc.) For instance, with respect to shopping malls, this will entail directing viewers by zip code to it stores to purchase specific products that they saw and experienced on the screen. For grocers, the program adds products to a shopping list and digital coupons to their loyalty card and smartphone at the click of a button.

Thus, as described by reference to FIGS. 1-4, the digital integration system provides free, hosted interactive content viewing, advertising, marketing, sales (online/on-site), branded content, digital coupon downloads, direct connections to loyalty cards, and automatic sweepstakes for login members. The system directly connects viewers to sales and gives advertisers the ability to monitor all of these transactions, demographics and behaviors. In this way, the system provides opportunities for live and/or direct interaction with viewers and provides the opportunity to support a local charity with one or more viewers. Furthermore, each viewer's privacy is protected by placing all tracked information into a privacy code for every login participant, thereby preventing any tagging of personal information to the information. The system also reaches beyond a mere sales and marketing platform by facilitating support for charities by advertisers and viewers, who may come together to support selected charities for each particular episode. In addition, because the digital integration system has no pre-roll and/or mid-roll commercials to interrupt viewer content, viewers are in complete control of the branded marketing and advertising they select for themselves. This also allows viewers to quickly progress through an episode without interruption.

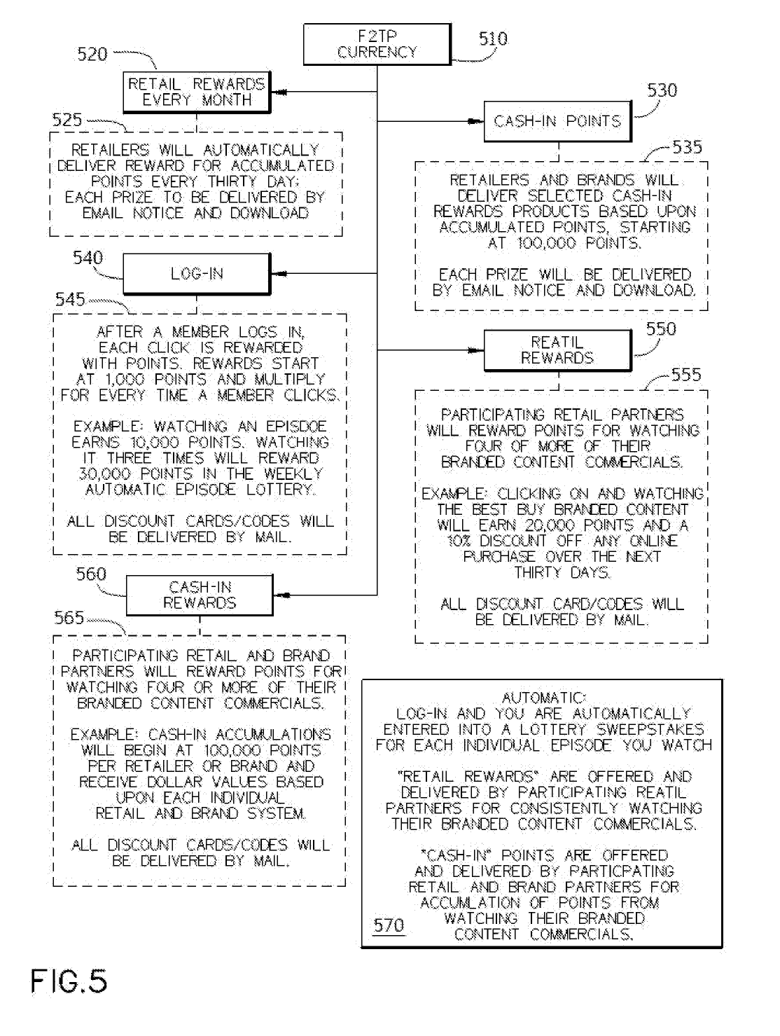

On top of these benefits, members automatically receive coupon downloads, direct sales offers, and sweepstakes points just for watching content episodes. Also, retailers and manufacturers can provide custom sweepstakes points and other offers. By way of example, FIG. 5 conceptually illustrates another digital integration system process for providing free, consumer-controlled multimedia content to consumers in some embodiments. As shown, different “currency” types 510 are provided, including recurring retail rewards 520 (e.g., recurring monthly, weekly, daily, etc.), cash-in points 530 (e.g., cash-in points for prizes/products), log-in rewards 540, accomplishment-based retail rewards 550 (e.g., watching branded commercials in connection with a content item selected for viewing), and cash-in rewards (e.g., discounts, cash, etc.). In addition, the system is a non-discretionary, automatic system 570 with respect to distribution of many currency types. For instance, the system automatically awarded points to a registered content consumer each time the consumer logs into the system, and the system automatically transmits points, coupons, offers, etc., to the computing device of the content consumer.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

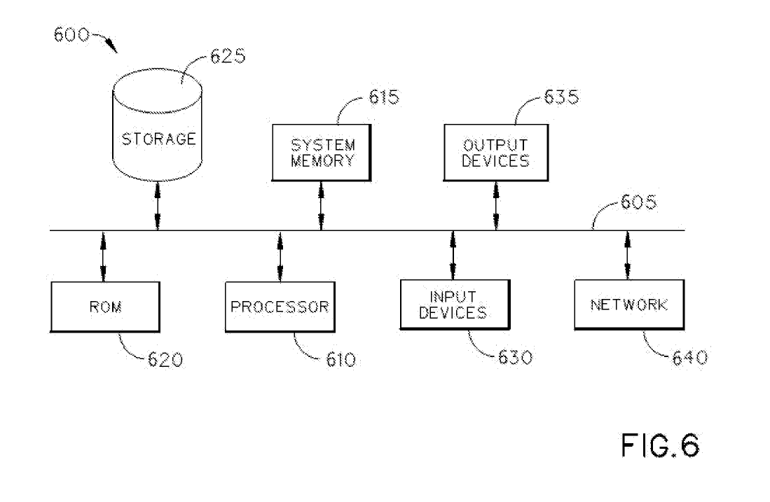

FIG. 6 conceptually illustrates an electronic system 600 with which some embodiments of the invention are implemented. The electronic system 600 may be a computer, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing or cursor control devices. The output devices 635 display images generated by the electronic system 600. The output devices 635 include printers and display devices, such as cathode ray tubes (CRT) or liquid crystal displays (LCD). Some embodiments include a touchscreen that functions as both an input and output device.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an Intranet), or a network of networks (such as the Internet). Any or all components of electronic system 600 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by sets of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process of the digital integration system is conceptually illustrated in FIGS. 1-4 and another process is illustrated in FIG. 5. The specific operations of these processes may not be performed in the exact order shown and described. Specific operations may not be performed in one continuous series of operations, and different specific operations may be performed in different embodiments. Furthermore, the processes could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A non-transitory computer readable medium storing a program which, when executed by at least one processing unit of a computing device, displays free, consumer-controlled multimedia content and provides a set of multimedia content integrations associated with the multimedia content comprising content hosting, advertising, marketing, and sales content associated with the multimedia content, said program comprising sets of instructions for:
hosting content for a viewer to watch;
performing a set of initialization operations;
receiving a content selection to play for the viewer;
displaying a sequence of clips from the playing content;
while the content is playing, displaying a content-associated token that increases a point value awarded to the viewer for viewing the content;
transmitting the point value to a computing device of the viewer after the content finishes playing;
displaying a set of selectable sponsor content links which when selected transmits a set of quasi-cash rewards to the computing device of the viewer; and
in each of a plurality of categories, selecting a set of winning viewers of the content.

2. The non-transitory computer readable medium of claim 1, wherein the hosted content is multimedia content comprising a television episode of a particular television show.

3. The non-transitory computer readable medium of claim 2, wherein the television episode comprises a set of branded products associated with a retailer.

4. The non-transitory computer readable medium of claim 3, wherein the program further comprises a set of instructions for receiving a selection within the television episode of a branded product in the set of branded products.

5. The non-transitory computer readable medium of claim 3, wherein the program further comprises sets of instructions for:
redirecting the viewer to an online website of the retailer; and
displaying the selected branded product.

6. The non-transitory computer readable medium of claim 1, wherein the point value is redeemable for a rebate from a manufacturer.

7. The non-transitory computer readable medium of claim 1, wherein the quasi-cash rewards are online coupons associated with a manufacturer.

8. A digital multimedia content integration system that integrates subsystems for content distribution, advertising, marketing, and sales in each of a set of multimedia content platforms to provide free, consumer-controlled multimedia content, said digital integration system comprising:
a multimedia content server computing device comprising a set of programs for distributing multimedia content to a set of registered content consumers, wherein the set of programs comprises a content consumer registration program that registers content consumers to access and view free, consumer-controlled multimedia content and a web server program configured to host a website that is communicatively connected across a network to a computing device of each registered content consumer, said web server program comprising program modules that (i) provide, to the computing device of a particular registered content consumer, access to a set of multimedia content items to view on the computing device, (ii) receive, from the computing device, a selection of a particular multimedia content item in the set of multimedia content items, and (ii) transmit, to the computing device, the particular multimedia content item;
a content database comprising a set of multimedia content items for viewing by registered content consumers and a set of sponsor data for sponsoring free viewing of the multimedia content items by the registered content consumers, said content database accessible by the web server to retrieve the particular multimedia content item and a set of sponsor data to transmit to the computing device of the particular registered content consumer; and
a sweepstakes server computing device comprising a set of programs for (i) awarding sweepstakes points to registered content consumers and (ii) conducting a sweepstakes contest between all registered content consumers with one or more sweepstakes points to determine a set of winning content consumers, and (iii) awarding a sweepstakes prize from a set of sweepstakes prize categories to each winning content consumer.

9. The digital multimedia content integration system of claim 8, wherein sweepstakes points are awarded to a registered content for each of (i) logging into the digital multimedia content integration system and (ii) viewing a multimedia content item.

10. The digital multimedia content integration system of claim 8, wherein the set of sweepstakes prize categories comprises a new car prize category, a smart TV prize category, and a gift certificate prize category.
